(19) United States
(12) Patent Application Publication
(10) Pub. No.: US 2025/0307613 A1
(43) Pub. Date: Oct. 2, 2025

(54) INTERPRETING COMMANDS BASED ON AI-ASSISTED GENERATION OF COMMAND CONSTRUCTIONS

(71) Applicant: Microsoft Technology Licensing, LLC, Redmond, WA (US)

(72) Inventors: Umesh MADAN, Bellevue, WA (US); Steven Edward LUCCO, Bellevue, WA (US); Curtis Cheng-Cheng MAN, Seattle, WA (US)

(73) Assignee: Microsoft Technology Licensing, LLC, Redmond, WA (US)

(21) Appl. No.: 18/624,700

(22) Filed: Apr. 2, 2024

(51) Int. Cl. G06N 3/0455

(52) U.S. Cl. CPC G06N 3/0455

(57) ABSTRACT

A computing system stores a constructions database comprising a plurality of command constructions and executes an orchestrator, which receives a request including a message as natural language input from an interaction interface, performs a matching operation that attempts to match the message to one of the plurality of command constructions, and responsive to successfully matching the message to the one of the plurality of command constructions, generates a command based on the one of the plurality of command constructions, and executes the generated command.

### BACKGROUND

The advent of generative models, especially large language models, has significantly advanced human-computer interactions. These models are trained on extensive data sets that enable them to generate text which can be coherent, contextually relevant, and insightful. Users often interact with these generative models through various platforms, inputting inquiries, asking questions, or seeking advice on a wide range of topics. Such interactions can span simple queries like asking for the weather forecast to complex discussions about philosophy, technology, and beyond.

However, a key challenge that persists in the realm of generative models and natural language processing technologies is the significant computational cost associated with running these models and systems. In many situations, the generative model is hosted at a server and the conversational interface is executed at a client. The processing power and memory required to generate responses in real-time can be substantial, leading to high energy consumption and processing latency. The communications latency involved in round trip communications between client and server for model interactions via the conversational interfaces can also be significant. As multimodal generative models emerge, such conversational interfaces may be augmented or modified to accept input in other modalities, such as image input and touch input, further increasing the technical complexity of the generative model computations.

It is anticipated that conversational interfaces will be increasingly used for human-computer interaction in the future. The growing reliance on such server-based generative models that service client-based conversational interfaces may lead to escalating computational loads, data storage requirements, network bandwidth requirements, latency, and energy consumption. For both end-users and software developers, these factors can be a significant barrier to adoption and usage. This presents an opportunity to address such technical challenges and achieve more efficiency in systems that utilize generative models.

### SUMMARY

To address the above issues, a computing system for interpreting commands is provided, comprising processing circuitry and associated memory. The processing circuitry is configured to store a constructions database comprising a plurality of command constructions and execute an orchestrator, which receives a request including a message as natural language input from an interaction interface, performs a matching operation that attempts to match the message to one of the plurality of command constructions, and responsive to successfully matching the message to the one of the plurality of command constructions, generates a command based on the one of the plurality of command constructions, and execute the generated command.

Responsive to failing to match the message to the one of the plurality of command constructions, the orchestrator may input the message into a trained generative language model to generate a command corresponding to the message, and execute the generated command. The orchestrator may be further configured to, for the generated command, input a prompt into the trained generative language model to inquire how the command was generated, so as to generate a command explanation, and incorporate the command explanation into the constructions database.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view showing a computing system according to a first example implementation, in which a client computing device generates a command from a user's natural language input using a local process or by using a trained generative model hosted on a server.

FIG. 2 is a schematic view showing a computing system according to a second example implementation, in which a client computing device executing a workflow instance generates a command from a user's natural language input using a local process or by using a trained generative model hosted on a server.

FIG. 3 is a schematic view showing a computing system according to a third example implementation, which uses a constructions database to generate commands based on natural language requests, and uses a trained generative language model to build the constructions database.

FIG. 4 is a schematic view showing a computing system according to a second example implementation, which uses a constructions database to generate commands based on natural language requests, and uses a trained generative language model to build the constructions database.

FIG. 5 is a detailed view showing the functions of the orchestrator, agent cache, constructions database, trained generative language model, and agent of the computing system of FIGS. 3 and 4.

FIG. 6 shows a flowchart for a first method for use in generating an executable machine command from a natural language request.

FIG. 7 shows a flowchart for a first method for use in generating an executable machine command from a natural language request.

FIG. 8 shows a schematic view of an example computing environment in which the computing system of FIGS. 3-5 may be enacted.

### DETAILED DESCRIPTION

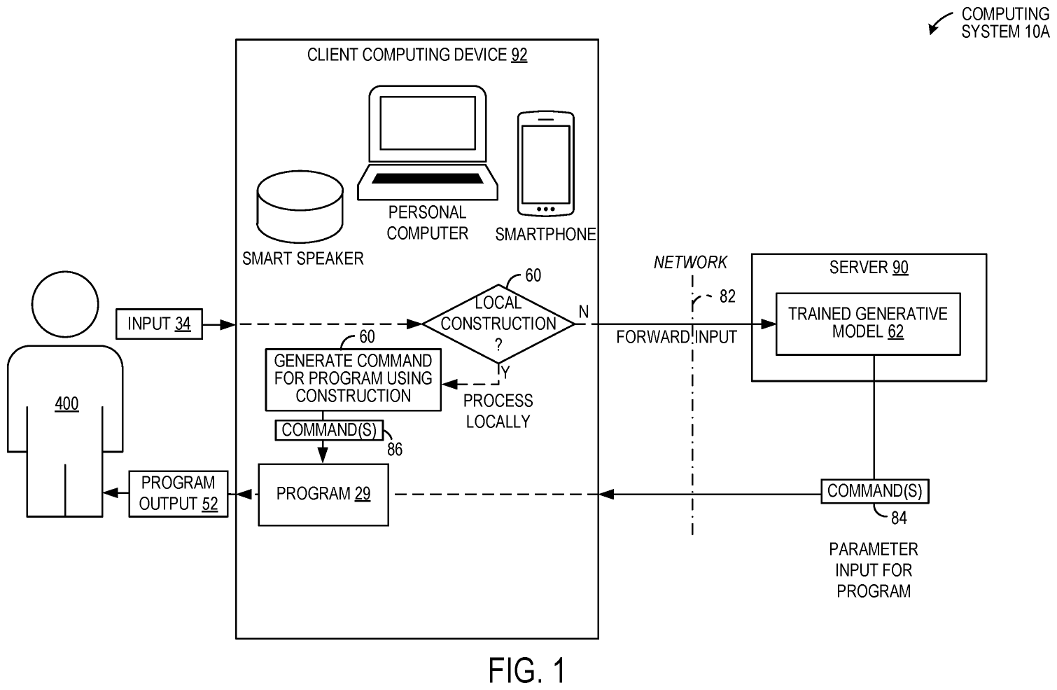

To address the issues described above, referring to FIG. 1, a computing system 10A is provided according to a first example implementation to generate commands 84, 86, including parameters for a program 29, corresponding to natural language input 34 from a user 400. In this example implementation, the user 400 inputs a natural language input 34 into a client computing device 92, which may be a smart speaker, a personal computer, or a smartphone, for example. The natural language input 34 may be voice transcribed into text, or text that is directly typed into a user interface of the client computing device 92 by the user 400, for example. The client computing device receives the natural language input 34, and executes an algorithm 60 to determine whether a command corresponding to the natural language input 34 can be generated using a local process on the client computing device 92. The algorithm 60 performs a matching operation that attempts to match the natural language input 34 to one of a plurality of command constructions in a constructions database stored on the client computing device 92. Alternatively, the constructions database may be stored on a server computing device 90. A command construction is a sequence of semantic components (words or word tokens) extracted from natural language input of users that has been associated with a command input to a program, such as “Play a song by Taylor Swift”.

The command construction can include words or word tokens that have been categorized as actions, objects, prepositions, and modifiers, for example. The command constructions database can be created by storing a history of natural language inputs from users and associated commands that were implemented in response to those inputs by the computing system, with positive feedback by the user indicating that the commands were interpreted by the computing system correctly.

Different forms of input that are determined to be associated with a same command can be aggregated together such that the system can recognize variations in natural language input that map to the same command. Therefore, generalized patterns of the different forms of input may be associated with the same command, thereby capturing the essence of how the natural language inputs are structured, rather than cataloging discrete instances of such natural language inputs. These generalized patterns may be formulated by distilling the different command constructions into abstracted templates which represent the structure of commands within certain categories. For example, an abstracted template may encapsulate the general request format for playing music, which could then be applied to any specific artist or song, even if that precise music request has not been encountered before. Accordingly, privacy considerations may be addressed by ensuring that the command constructions database operates independently of any private user information. By abstracting and generalizing specific details from user inputs, the command constructions database derives generalized patterns which reflect the manner in which the commands are typically made.

When a match of the input 34 to a command construction among the plurality of command constructions in the command constructions database is found, the algorithm 60 determines that the command can be generated through a local process on the client computing device 92. In response to this determination, the algorithm 60 generates one or a plurality of commands 86 for a program 29 using the matching command construction. The command(s) 86 is output to and executed by the program 29, which in turn outputs a program output 52 which is received by the user 400. In the example of “Play a song by Taylor Swift” the program 29 could be a music player, and the output could be audio output of a song by Taylor Swift.

When the algorithm 60 determines that the command cannot be generated through a local process on the client computing device 92, then the algorithm 60 forwards the natural language input 32 through a network 82 to a trained generative model 62 hosted on a server computing device 90. Responsive to receiving the forwarded natural language input 32, the trained generative model 62 generates one or a plurality of commands 84 corresponding to the natural language input 32. When a plurality of commands 84 corresponds to the natural language input 32, the algorithm 60 may include a selection algorithm that is executed to select one or a subset of the plurality of commands 84 for further processing. Responsive to selecting the one or the subset of the plurality of commands 84, the algorithm 60 sends the one or the subset of the generated command(s) 84 to the program 29 executed on the client computing device 92. In response, the program 29 outputs the program output 52 which is received by the user 400.

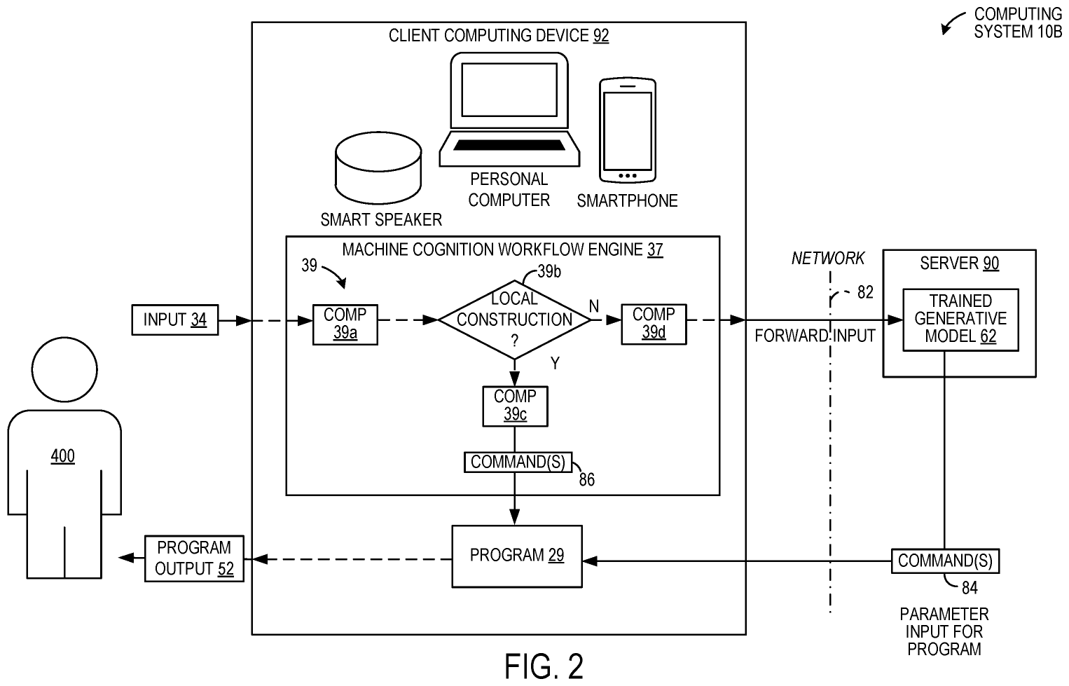

Referring to FIG. 2, a computing system 10B is provided according to a second example implementation, in which a machine cognition workflow engine 37 hosted on the client computing device 92 executes a workflow instance 39 which receives the natural language input 34 from the user 400. A first component 39a of the workflow instance 39 processes the input 34 and then outputs a context which is received by a second component 39b, which determines whether a command corresponding to the natural language input 34 can be generated using a local process on the client computing device 92. The second component 39b performs a matching operation that attempts to match the natural language input 34 to one of a plurality of command constructions in a constructions database stored on the client computing device 92. When the second component 39b determines that the command can be generated through a local process on the client computing device 92, then the second component 39b executes a third component 39c, which generates a command 86 for a program 29 using the matching command construction among the one or the plurality of command constructions. The command(s) 86 is executed by the program 29, which outputs a program output 52 which is received by the user 400.

When the second component 39b determines that the command cannot be generated through a local process on the client computing device 92, then the second component 39b executes a fourth component 39b, which forwards the natural language input 32 through a network 82 to a trained generative model 62 hosted on the server computing device 90. Responsive to receiving the forwarded natural language input 32, the trained generative model 62 generates one or a plurality of commands 84 corresponding to the natural language input 32, and sends the generated command(s) 84 to the program 29 executed on the client computing device 92. In response, the program 29 outputs the program output 52 which is received by the user 400.

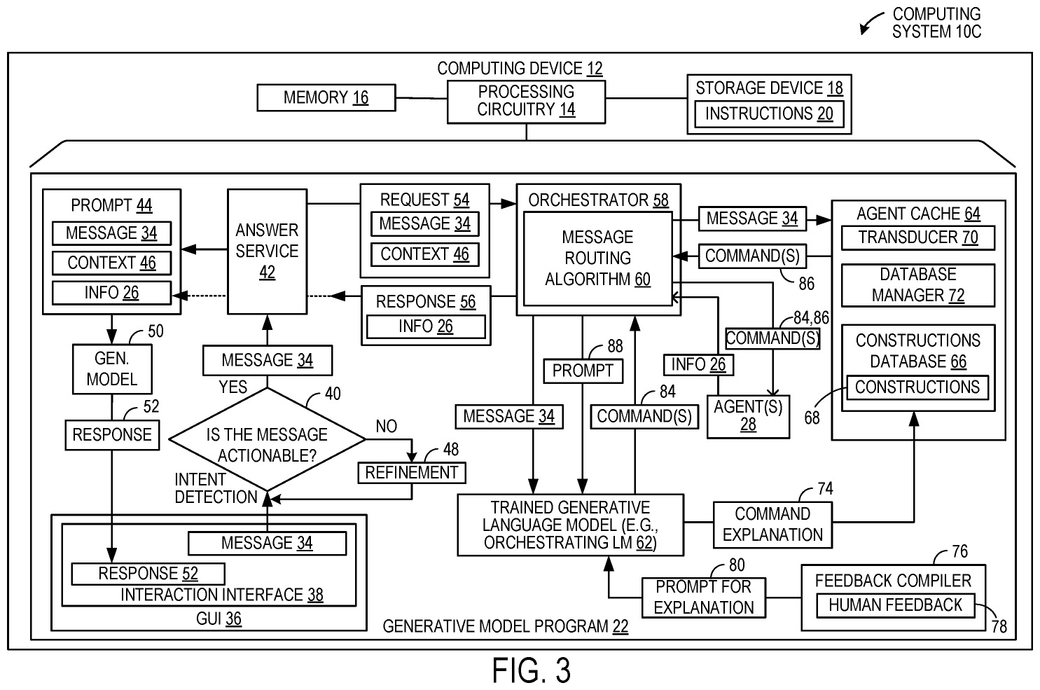

FIG. 3 illustrates a schematic view of a computing system 10C for generating commands based on natural language input from users, according to a third example implementation. For the sake of clarity, the trained generative model 50 will be henceforth referred to as a trained generative language model 50. However, it will be noted that the term ‘trained generative language model’ is merely illustrative, and the underlying concepts encompass a broader range of generative models, including multi-modal models, diffusion models, and generative adversarial networks, which may receive text, image, and/or audio inputs and generate text, image, and/or audio outputs, as discussed in further detail below.

The computing system 10C includes a computing device 12 having processing circuitry 14, memory 16, and a storage device 18 storing instructions 20. In this third example implementation, the computing system 10C takes the form of a single computing device 12 storing instructions 20 in the storage device 18, including a constructions database 66 comprising a plurality of command constructions 68, and a generative model program 22 that is executable by the processing circuitry 14 to perform various functions including executing a plurality of agents 28, causing an interaction interface 38 for a generative model 50 to be presented, receiving, via the interaction interface 38, a message 34 from the user, extracting a context 46 of the message 34, and generating a request 54 including the context 46 and the message 34. The plurality of agents 28 are each configured to perform a task and/or retrieve information in specialized domains of the one or more agents 28.

The processing circuitry 14 further executes an orchestrator 58 configured to receive the request 54 including a message 34 as natural language input from the interaction interface 38, and perform a matching operation that attempts to match the message 34 to one of the plurality of command constructions 68 in the constructions database 66.

Responsive to successfully matching the message 34 to the one of the plurality of command constructions 68, the agent cache 64 generates a command 86 based on the one of the plurality of command constructions 68, and the orchestrator 58 executes the generated command 86. On the other hand, responsive to failing to match the message 34 to the one of the plurality of command constructions 68, the orchestrator 58 inputs the message 34 into the trained generative language model 62 to generate a command 84 corresponding to the message 34, and executes the generated command 84, which may be an executable machine command, or a machine-readable command which may be in JSON or XML formats, for example. Alternatively, instead of an orchestrator 58, deterministic programming logic may be used to communicate with the constructions database 66 and determine whether or not the message 34 matches to one of the plurality of command constructions 68, and whether or not to input the message 34 into the trained generative language model 62.

The orchestrator 58 is further configured to, for the generated command 84, input a prompt 88 into the trained generative language model 62 to inquire how the command 84 was generated, so as to generate a command explanation 74, and incorporate the command explanation 74 into the constructions database 66.

In some instances, the interaction interface 38 may be a portion of a graphical user interface (GUI) 36 for accepting user input and presenting information to a user. In other instances, the interaction interface 38 may be presented in non-visual formats such as an audio interface for receiving and/or outputting audio, such as may be used with a digital assistant. In yet another example the interaction interface 38 may be implemented as an application programming interface (API). In such a configuration, the input to the interaction interface 38 may be made by an API call from a calling software program to the interaction interface API, and output may be returned in an API response from the interaction interface API to the calling software program. The API may be a local API or a remote API accessible via a computer network such as the Internet. It will be understood that distributed processing strategies may be implemented to execute the software described herein, and the processing circuitry 14 therefore may include multiple processing devices, such as cores of a central processing unit, co-processors, graphics processing units, field programmable gate arrays (FPGA) accelerators, tensor processing units, etc., and these multiple processing devices may be positioned within one or more computing devices, and may be connected by an interconnect (when within the same device) or via a packet switched network links (when in multiple computing devices), for example. Thus, the processing circuitry 14 may be configured to execute the interaction interface API (for example, interaction interface 38) for the trained generative model 50, so that the processing circuitry 14 is configured to interface with the trained generative model 50 that receives input of the prompt 44 including natural language text input and, in response, generates a response 52 that includes natural language text output. Likewise, communications between the orchestrator 58 and agents 28 and the trained generative language model 62 can be implemented using local or remote APIs.

Responsive to receiving a message 34 at the interaction interface 38, at decision point 40, the system 10C determines whether the message 34 is actionable, and if so then attempts to generate a response 52 to the message 34 using the generative model 50, calling an answer service 42 to generate a prompt 44 based at least on natural language text input 34 from the user, and provide the prompt 44 to the trained generative model 50. The trained generative language model 50 receives the prompt 44, which includes the natural language text input 34 from the user for the trained generative language model 50 to generate a response 52, and generates, in response to the prompt 44, the response 52 which is outputted to the user. Otherwise, at decision point 40, when the system 10C determines that the message 34 is not actionable, a refinement process 48 is executed to withhold the message 34 from the answer service 42 and perform other processes to refine intent detection on the message 34, until the system 10C determines that the message 34 is actionable.

When the system 10C determines that the message 34 contains a plurality of actionable parts, the answer service 42 may extract a context 46 from the message 34, and generate a request 54 comprising the message 34 and the context 46. The answer service 42 inputs the request 54 into the orchestrator 58 which is configured to perform a matching operation that attempts to match the message 34 to one of the plurality of command constructions 68 in the constructions database 66.

It will be understood that the natural language text input 34 may also be generated by and received from a software program, rather than directly from a human user. The software program may use an AI model to explore a set of likely user scenarios by creating pairs of input requests and constructions 66, and populating the constructions database 66 with constructions 68 that match those input requests, so that new constructions 66 can be learned through the generative output of the AI model which does not involve direct interactions with users. It will also be understood that each of the trained generative language models described herein operates on natural language input that is tokenized into a vector of input tokens, and generates a vector of output tokens as a result, which is then converted into natural language output.

The trained generative language model 50 is a generative model that has been configured through machine learning to receive input that includes natural language text and generate output that includes natural language text in response to the input. It will be appreciated that the trained generative language model 50 can be a large language model (LLM) having tens of millions to billions of parameters, non-limiting examples of which include GPT-3, BLOOM, and LLaMa-2. The trained generative language model 50 can be a multi-modal generative model configured to receive multi-modal input including natural language text input as a first mode of input and image, video, or audio as a second mode of input, and generate output including natural language text based on the multi-modal input. The output of the multi-modal model may additionally include a second mode of output such as image, video, or audio output. Non-limiting examples of multi-modal generative models include Kosmos-2 and GPT-4 VISUAL. Further, the trained generative language model 50 can be configured to have a generative pre-trained transformer architecture, examples of which are used in the GPT-3 and GPT-4 models.

The orchestrator 58 may execute a message routing algorithm 60 to route the message 34 to an agent cache 64 which performs the matching operation that attempts to match the message 34 to one of the plurality of command constructions 68 in the constructions database 66.

The agent cache 64 may be provided with a transducer function 70 configured to implement part-of-speech tagging to take the sequence of words in the message 34 as its input and convert the message 34 into a construction of a sequence of semantic components including actions, objects, prepositions, and modifiers. The transducer function 70 may include an algorithm which is configured to parse the message 34 into a syntactic tree, breaking down the message 34 into its grammatical components, including nouns, verbs, adjectives, prepositions, and organizing them into a hierarchical tree structure, parsing the tree to identify actions, objects, prepositions, and modifiers as key phrases, and then constructing a sequence of semantic components including the identified key phrases.

The agent cache 64 then performs the matching operation to attempt to match the construction, which was converted from the message 34 to an existing construction among the plurality of constructions 68 in the constructions database 66. Responsive to successfully matching the message 34 to the one of the plurality of command constructions 68, the agent cache 64 may generate and return a command 86 based on the matching command construction, and the message routing algorithm 60 may cause the orchestrator 58 to execute the generated command 86. On the other hand, responsive to failing to match the message 34 to the one of the plurality of command constructions 68, the message routing algorithm 60 may cause the orchestrator 58 to input the message 34 into the trained generative language model 62 to generate a command 84 corresponding to the message 34, and cause one of the plurality of agents 28 to execute the generated command 84.

The message routing algorithm 60 may cause the orchestrator 58 to generate and send a prompt 88 to the trained generative language model 62. The prompt 88 may include a question inquiring how the command 84 was generated. Responsive to receiving the prompt 88, the trained generative language model 62 may then generate and return a command explanation 74 explaining how the command 84 was generated. Accordingly, the orchestrator 58 may use the trained generative language model 62 to generate and send the command 84, to a subset of the plurality of agents 28, as well as generate a command explanation 74 which is subsequently incorporated into the constructions database 66 as one of the plurality of constructions 68. The message routing algorithm 60 may also use the trained generative language model 62 to explore a set of likely user scenarios by creating input requests 88 and ensuring that the constructions database 66 includes constructions 68 to match those input requests 88.

The command explanation 74 may be generated by the trained generative language model 62 by parsing the message 34 into sub-phrases, and categorizing each sub-phrase into categories including at least an action and an action parameter, and synonyms for each sub-phrase. The categories may include predetermined common parameter types including days of the week. When the message 34 includes an indication of a schema of a target database, the generated command explanation 74 may include an indication of a column name or ordinal value for a row in the target database, for example.

The command explanation 74 may be further refined by inputting external feedback into the trained generative language model 62. For example, a feedback compiler 76 may compile human feedback 78 including descriptions of messages that were translated into incorrect commands. Such descriptions may be incorporated into a prompt 80 for explanation which is inputted into the trained generative language model 62 to fine-tune or refine the generation of the command explanation 74.

When the agent cache 64 receives the command explanation 74 to incorporate as one of the plurality of constructions 68 in the constructions database 66, a database manager 72 may consolidate the constructions database 66 by merging the constructions 68 based on common categories or category member lists. Further, the database manager 72 may update the constructions database 66 based on changes in usage detected in inputs from users. For example, the synonyms for the actions and objects included in the constructions 68 may be expanded depending on the latest vernacular that is used online. The synonym groups and/or category member lists may be expanded using AI models, for example.

The agent 28 receiving the command 84 executes command handling logic to receive the command 84, and executes command processing logic to process the command 84 and perform a task and/or retrieve information in the specialized domain of the agent 28 receiving the command 84.

The agents 28 may be instantiated as specialized software modules configured to handle specific domains of tasks or requests. The agents 28 may be generative modules configured with specialized algorithms or processing capabilities to execute specific tasks in various specialized domains, which may include but are not limited to document editing, program development, music, finance, healthcare, artwork, game design, and food services. The agents 28 are configured to retrieve information and/or perform tasks that directly align with their areas of expertise.

The command 84 may be encoded in JSON, XML, or any other suitable data-interchange format that encapsulates the user's intent, query parameters, and other context-relevant information. The command handling logic processes the command 84 to generate actionable data, which becomes input for the command processing logic executed by the agent 28. The command processing logic may interact with APIs of other services to retrieve data or perform actions or directly interact with relational databases to run queries and retrieve relevant information, for example.

After retrieving relevant information 26 from the agents 28, the orchestrator 58 may generate a response 56 containing the retrieved relevant information 26. The answer service 42 generates the prompt 44 based on the message 34 from the user, the context 46 extracted from the message 34, and the relevant information 26 retrieved by the orchestrator 58. The prompt 44 is inputted into the generative language model 50, which in turn generates the response 52 and returns the response 52 for display to the user via the interaction interface 38.

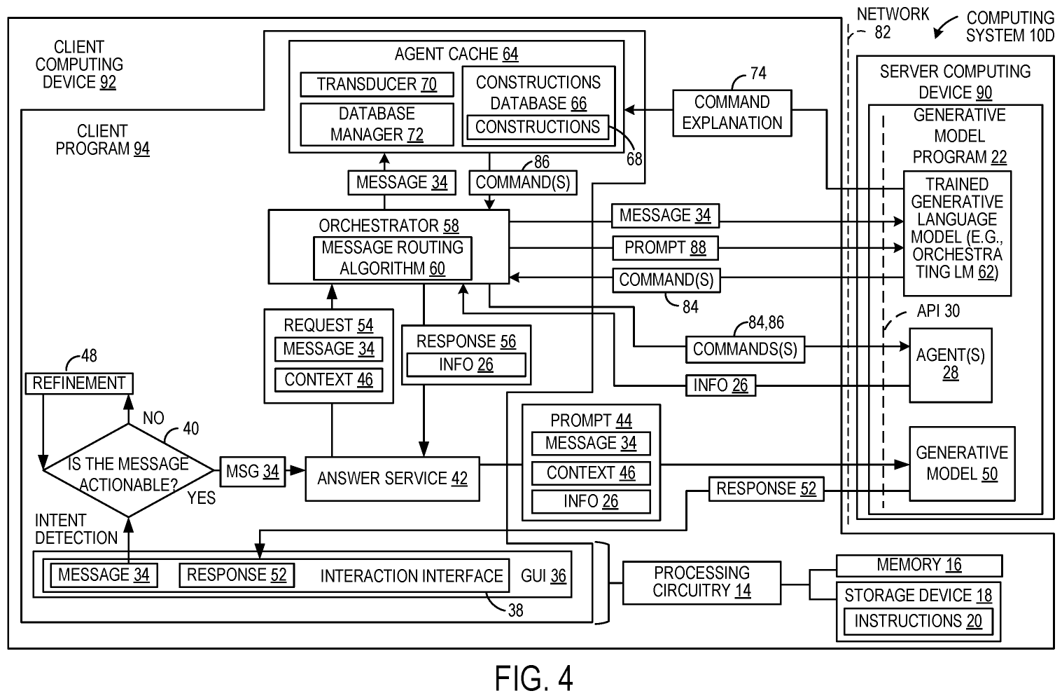

Turning to FIG. 4, a computing system 10D according to a second example implementation is illustrated, in which the computing system 10D includes a server computing device 90 and a client computing device 92 which communicate with each other via a network such as the Internet. Here, both the server computing device 90 and the client computing device 92 may include respective processing circuitry 14, memory 16, and storage devices 18. Description of identical components to those in FIG. 3 will not be repeated. As shown in FIG. 4, the plurality of agents 28, generative models 50, 62 and the generative model program 22 can be stored and executed on a different server 90 from the client computing device 92. The interaction interface 38 is executed by the client computing device 92, which stores and executes the client program 94 including the answer service 42, orchestrator 58, and the agent cache 64 with the constructions database 66. The client program 94 executed on the client computing device 92 can send a request or message 34 to an API 30 of the generative model program 22 on the different server 90 across a computer network such as the Internet, and in turn receive a response, in some examples.

It will be appreciated that the server computing device 90 may be one of a plurality of servers in a server pool that is configured to implement a cloud computing platform, and that the generative model program 22 may be accessed via an API 30 of the cloud computing platform. The generative model program 22 may be implemented in a virtual machine or containerized computing environment on the server computing device 90, in some configurations.

The client computing device 92 may be configured to present the interaction interface 38 as a result of executing a client program 94 by the processing circuitry 14 of the client computing device 92. The client computing device 92 may be responsible for communicating between the user operating the client computing device 92 and the server computing device 90 which executes the generative model program 22 and contains respective agents 28 and the generative models 50, 62 via an API 30 of the generative model program 22. The client computing device 92 may take the form of a personal computer, laptop, tablet, smartphone, smart speaker, etc.

Further, the generative language models 50, 62 may be executed on a different server from the server computing device 90 depicted in FIG. 4, so that the client computing device 92 is in communication with the generative language models 50, 62 hosted on the server computing device 90 via a network 82, such as the Internet. In such an embodiment, the server computing device 90 may invoke an API call to transmit a data request to a different external server executing the generative language models 50, 62. Upon receipt of the data request, the external server may decode the incoming API call and extract input parameters, receiving input of the prompt including natural language text input. The API of the generative language models 50, 62 acting as a gateway, may channel the input of the prompt into the generative language models 50, 62 for processing. The generative language models 50, 62 executed on the external server, may perform its operations and generate a response that includes natural text output. The response may be encapsulated by the API of the generative language model 50 and transmitted back to the server computing device 90, which receives, in response to the prompt, the response from the trained generative models 50, 62 and output the response to the user.

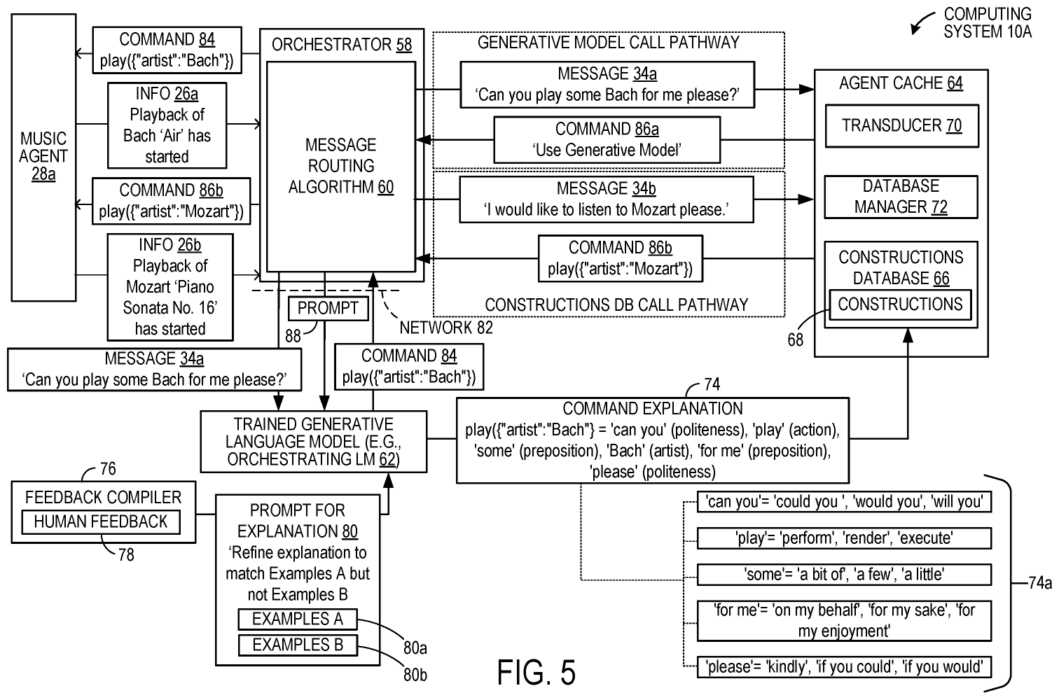

Turning now to FIG. 5, interaction between the orchestrator 58, the trained generative language model 62, the plurality of agents 28, and the agent cache 64 with the constructions database 66 of FIG. 3 is shown in detail. Initially, a natural language input is received at the orchestrator 58 in the form of message 34 from the interaction interface 38 shown in FIG. 3. The example of FIG. 5 includes two messages 34a, 34b: the first message 34a asks, ‘Can you play some Bach for me please?’ and the second message 34b asks, ‘I would like to listen to Mozart please.’ FIG. 5 illustrates two pathways: a generative model call pathway, in which the command 84 for the message 34a is generated by the trained generative language model 62, and a constructions database call pathway, in which the command 86b for the message 34b is generated by the agent cache 64 using the constructions database 66.

The message 34a, 34b is typically received in a request 54, which also includes context 46. The message 34a, 34b is typically inputted by a user, and the context 46 typically includes a user interaction history of messages exchanged between the generative model and user in a session. The orchestrator 58 is configured to route the first message 34a to the agent cache 64, which performs a matching operation to attempt to match the message 34a to one of the plurality of constructions 68 in the constructions database 66. However, the agent cache 64 fails to match the message 34a to one of the plurality of constructions 68 in the constructions database 66. Therefore, the agent cache 64 returns a command 86a instructing the orchestrator 58 to use the trained generative language model 62 to generate the command 84.

Responsive to receiving the command 86a instructing the use of the trained generative language model 62, the orchestrator 58 inputs the message 34a into the trained generative language model 62 to generate a command 84 corresponding to the message 34. The orchestrator 58 then routes the command 84 to a music agent 28a, which executes the command 84 to select a song from Bach, play the song on a music app, and returns information 26a indicating that the playback of Bach ‘Air’ has started.

The orchestrator 58 then inputs, into the trained generative language model 62, a prompt 88 for the generated command 84 inquiring how the command 84 was generated. In response to the prompt 88, the trained generative language model 62 generates a command explanation 74, which explains how the command 84 was generated. As shown in the example of FIG. 5, the command explanation 74 is generated by parsing the message 34a into sub-phrases, and categorizing each sub-phrase into categories including at least an action and an action parameter, and synonyms for each sub-phrase.

In the command explanation 74 for the command 84 play ({“artist”: “Bach”}), the message 34a ‘Can you play some Bach for me please?’ is parsed into ‘can you’ (politeness), ‘play’ (action), ‘some’ (preposition), ‘Bach’ (artist), ‘for me’ (preposition), ‘please’ (politeness). Thus, by recognizing ‘play’ as the action phrase, and ‘Bach’ as the parameter phrase for the action phrase, the command 84 to play Bach can be generated. Here, politeness, action, preposition, and artist represent categories of a construction.

Further, the command explanation 74 also includes synonyms 74a for each sub-phrase that was parsed from the message 34a. The synonyms for ‘can you’ include ‘could you’, ‘would you’, and ‘will you’. The synonyms for ‘play’ include ‘perform’, ‘render’, and ‘execute’. The synonyms for ‘some’ include ‘a bit of’, ‘a few’, and ‘a little’. The synonyms for ‘for me’ include ‘on my behalf’, ‘for my sake’, and ‘for my enjoyment’. The synonyms for ‘please’ include ‘kindly’, ‘if you could’, and ‘if you would’. These synonyms are alternative phrases for each sub-phrase that would not change the meaning of the overall message 34a.

For parameter phrases the trained generative language model 62 may suggest synonyms which would change the meaning of the parameter phrase but not the meaning of the action phrase. For example, when the trained generative language model 62 generates synonyms for the parameter phrase “next Thursday”, the alternative phrase “the following Friday” may be generated. Thus, specific parameter phrases, such as time ranges, may be designated as ‘seeds’, or common parameter types for which the generative language model 62 generates alternative phrases. These ‘seeds’ may include days of the week, for example.

The command explanation 74 is generated as a construction with a sequence of categories, with synonyms or alternative phrases contained in each category. The generated command explanation 74 is subsequently stored as one of the plurality of constructions 68 in the constructions database 66. The database manager 72 may consolidate the plurality of constructions 68 to combine information from constructions, or merging constructions based on common categories. For example, when duplicate constructions with similar sequences of categories and synonyms are identified, the database manager 72 may delete redundant constructions from the constructions database 66.

In the constructions database call pathway, the orchestrator 58 is configured to route the second message 34b to the agent cache 64, which performs a matching operation to attempt to match the second message 34b to one of the plurality of constructions 68 in the constructions database 66. The agent cache 64 parses the second message 34b into the sub-phrases ‘I would like to’, ‘listen to’, ‘Mozart’, and ‘please’. Performing the matching operation, the agent cache 64 successfully matches the second message 34b to one of the plurality of command constructions: (politeness #1), (action), (artist), (politeness #2). In this matching command construction, the politeness #1 category has the terms ‘I would like to’, ‘I want to’, ‘Can you’, and ‘Please’. The action category has the terms ‘listen to’, ‘play’, ‘hear’, and ‘stream’. The politeness category #2 has the terms ‘please’, ‘kindly’, ‘if you could’, and ‘if you would’.

Responsive to successfully matching the second message 34b to the matching command construction, the agent cache 64 returns the command 86b, play ({“artist”: “Mozart”}). The orchestrator 58 then routes the command 86b to a music agent 28a, which executes the command 86b to select a song from Mozart, play the song on a music app, and returns information 26b indicating that the playback of Mozart's ‘Piano Sonata No. 16’ has started.

The feedback compiler 76 may be configured to collect external feedback 78 from human users regarding the accuracy and effectiveness of how their natural language requests are converted into specific commands. The feedback 78 may include the acceptance or rejection of each of the plurality of constructions 66 in the constructions database 66, which may indicate changes in usage as detected in inputs from human users. The feedback 78 may include positive examples 80a of effective translations of natural language requests into machine commands, and negative examples 80b of ineffective translations of natural language requests into machine commands. The feedback compiler 76 may then generate a prompt 80 requesting that the command explanation 74 be refined to match the positive examples 80a but not match the negative examples 80b. Accordingly, the generated command explanation 74 is refined to reflect the feedback 78 from human users.

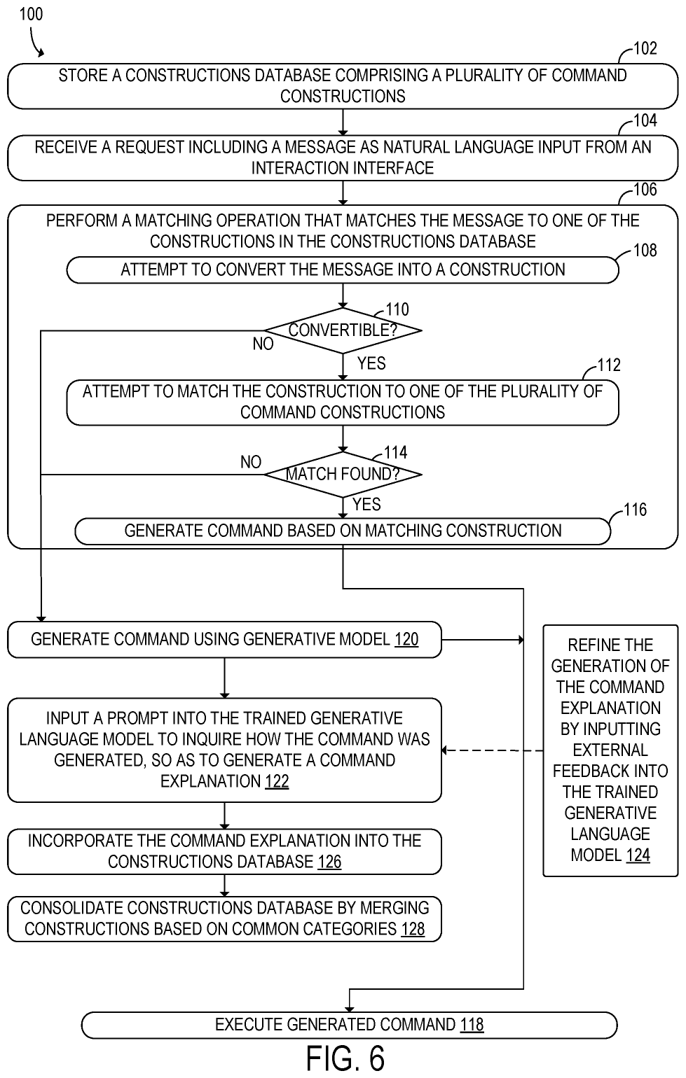

FIG. 6 is a flowchart that illustrates a first method 100 for using a constructions database to generate commands based on natural language requests, and using a trained generative language model to build the constructions database. The first method 100 may be implemented on the computing system 10C or 10D illustrated in FIGS. 3-5 above, which include processing circuitry and associated memory configured to implement an interaction interface, an orchestrator, an agent cache with a constructions database, a trained generative language model, and a plurality of agents. Alternatively, other suitable computing hardware and software may be utilized.

At 102, the method includes, at the orchestrator, receiving a request including a message having natural language input from the interaction interface. The interaction interface may be a graphical user interface or an application programming interface configured to implement a turn-based chat session between a user and an instance of the generative language model 50 described above, or between two or more instances of generative language models.

At 102, the method includes storing a constructions database comprising a plurality of command constructions. At 104, the method includes receiving a request including a message as natural language input from an interaction interface. At 106, the method includes performing a matching operation that attempts to match the message to one of the plurality of command constructions.

In step 106, at 108, the method attempts to convert the message into a construction. At 110, step 106 includes determining whether the message is convertible into a command using an agent cache. When it is determined that the message is not convertible into a command using the agent cache, the method proceeds to 120 to generate a command using a trained generative language model, and at 118, the generated command is executed. When it is determined that the message is convertible into a command using the agent cache, step 106 proceeds to 112 to generate a construction to perform the matching operation to match the construction to one of the plurality of command constructions. At 114, responsive to determining that a match has been detected, step 106 proceeds to 116 to generate a command based on the matching command construction, and at 118, the generated command is executed. At 114, responsive to determining that a match has not been detected, step 106 proceeds to 120 to generate a command using a trained generative language model, and at 118, the generated command is executed.

Following the generation of the command using the trained generative language model, at 122, the method includes inputting a prompt into the trained generative language model to inquire how the command was generated, so as to generate a command explanation. The command explanation may be generated by parsing the message into sub-phrases, and categorizing each sub-phrase into categories including at least an action and an action parameter, and synonyms for each sub-phrase. At 124, the method may include refining the generation of the command explanation by inputting external feedback into the trained generative language model.

At 126, the method includes incorporating the command explanation into the constructions database. At 128, the method includes consolidating the constructions database by merging constructions based on common categories.

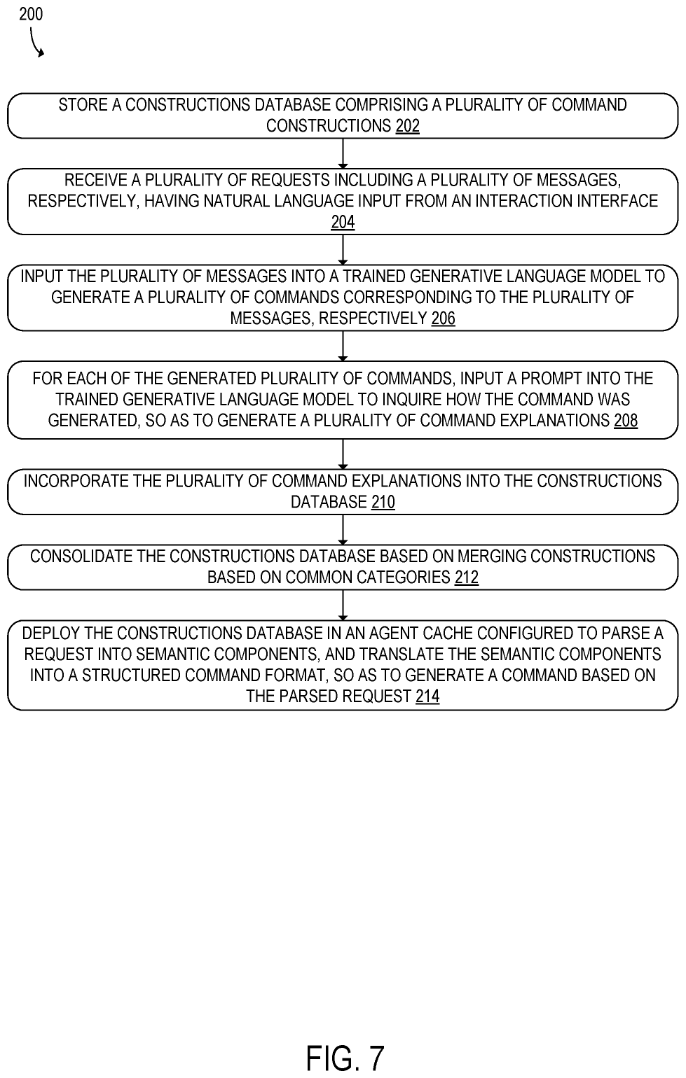

FIG. 7 is a flowchart that illustrates a second method 200 for using a constructions database to generate commands based on natural language requests, and using a trained generative language model to build the constructions database. The second method 200 may be implemented on the computing system 10C or 10D illustrated in FIGS. 3-5 above, which include processing circuitry and associated memory configured to implement an interaction interface, an orchestrator, an agent cache with a constructions database, a trained generative language model, and a plurality of response agents. Alternatively, other suitable computing hardware and software may be utilized.

At 202, the method includes storing a constructions database comprising a plurality of command constructions. At 204, the method includes receiving a plurality of requests including a plurality of messages, respectively, having natural language input from an interaction interface. At 206, the method includes inputting the plurality of messages into a trained generative language model to generate a plurality of commands corresponding to the plurality of messages, respectively.

At 208, the method includes, for each of the generated plurality of commands, inputting a prompt into the trained generative language model to inquire how the command was generated, so as to generate a plurality of command explanations. At 210, the method includes incorporating the plurality of command explanations into the constructions database. At 212, the method includes consolidating the constructions database based on merging constructions based on common categories. At 214, the method includes deploying the constructions database in an agent cache configured to parse a request into semantic components, and translate the semantic components into a structured command format, so as to generate a command based on the parsed request.

The above-described systems and methods describe the generation of commands using an agent cache with a constructions database comprising a plurality of command constructions, thereby reducing reliance on resource-intensive generative models without compromising user experience in engaging with complex tasks and specialized information queries, thereby potentially improving access to advanced conversational interfaces by making them more cost effective and sustainable.

In the above-described systems and methods, it will be appreciated that the term “commands” encompasses a broad range of language constructions, extending beyond the conventional interpretation of commands as mere imperatives or directives. It will be appreciated that the term “commands” will be interpreted to include, but not limited to, JSCON documents and structured records designed for interactive forms, as well as any mapping of language to structure in general in multitudes of digital environments.

In some embodiments, the methods and processes described herein may be tied to a computing system of one or more computing devices. In particular, such methods and processes may be implemented as a computer-application program or service, an API, a library, and/or other computer-program product.

In some embodiments, the methods and processes described herein may be tied to a computing system of one or more computing devices. In particular, such methods and processes may be implemented as a computer-application program or service, an application-programming interface (API), a library, and/or other computer-program product.

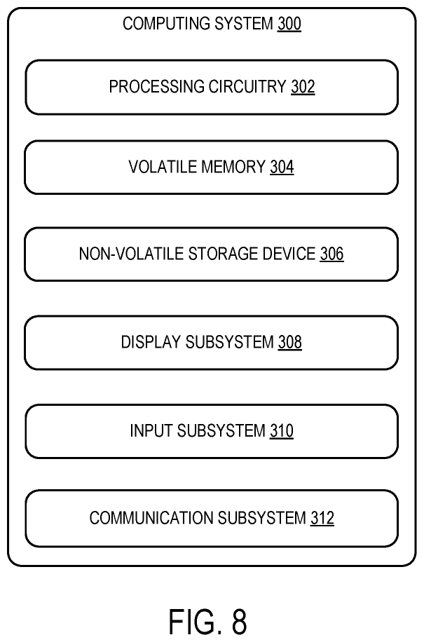

FIG. 8 schematically shows a non-limiting embodiment of a computing system 300 that can enact one or more of the methods and processes described above. Computing system 300 is shown in simplified form. Computing system 300 may embody the computing system 10C or 10D described above and illustrated in FIGS. 3 and 4, respectively. Components of computing system 300 may be included in one or more personal computers, server computers, tablet computers, home-entertainment computers, network computing devices, video game devices, mobile computing devices, mobile communication devices (for example, smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 8.

Processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included display subsystem 308 may be used to present a visual representation of data held by non-volatile storage device 306. The visual representation may take the form of a GUI. As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs provide additional support for the claims of the subject application. One aspect provides a computing system for interpreting commands. The system comprises processing circuitry and associated memory configured to store a constructions database comprising a plurality of command constructions, and execute an orchestrator to receive a request including a message as natural language input from an interaction interface, perform a matching operation that attempts to match the message to one of the plurality of command constructions, and responsive to successfully matching the message to the one of the plurality of command constructions, generate a command based on the one of the plurality of command constructions, and execute the generated command. In this aspect, additionally or alternatively, responsive to failing to match the message to the one of the plurality of command constructions, the orchestrator may input the message into a trained generative language model to generate a command corresponding to the message, and may execute the generated command. In this aspect, additionally or alternatively, the orchestrator may be further configured to for the generated command, input a prompt into the trained generative language model to inquire how the command was generated, so as to generate a command explanation, and incorporate the command explanation into the constructions database. In this aspect, additionally or alternatively, the generation of the command explanation may be refined by inputting external feedback into the trained generative language model. In this aspect, additionally or alternatively, the trained generative language model may generate a command explanation by parsing the message into sub-phrases, and categorizing each sub-phrase into categories including at least an action and an action parameter, and synonyms for each sub-phrase. In this aspect, additionally or alternatively, the categories may include predetermined common parameter types including days of the week. In this aspect, additionally or alternatively, the constructions database may be consolidated by merging constructions based on common categories. In this aspect, additionally or alternatively, the system may further comprise a server computing device and a client computing device, and the orchestrator and the constructions database may be stored on the client computing device, and the trained generative language model may be stored on the server computing device. In this aspect, additionally or alternatively, the command may be generated by the trained generative language model with a transducer function implementing part-of-speech tagging. In this aspect, additionally or alternatively, the constructions are formatted as a sequence of semantic components including actions, objects, prepositions, and modifiers. In this aspect, additionally or alternatively, the constructions database may be updated based on changes in usage detected in inputs from users of the computing system.

Another aspect provides a computing method for interpreting commands. The method comprises storing a constructions database comprising a plurality of command constructions, receiving a request including a message as natural language input from an interaction interface, performing a matching operation that attempts to match the message to one of the plurality of command constructions, and responsive to successfully matching the message to the one of the plurality of command constructions, generating a command based on the one of the plurality of command constructions, and executing the generated command In this aspect, additionally or alternatively, responsive to failing to match the message to the one of the plurality of command constructions, the message may be inputted into a trained generative language model to generate a command corresponding to the message, and the generated command may be executed. In this aspect, additionally or alternatively, the method may further comprise for the generated command, inputting a prompt into the trained generative language model to inquire how the command was generated, so as to generate a command explanation, and incorporating the command explanation into the constructions database. In this aspect, additionally or alternatively, the generation of the command explanation may be refined by inputting external feedback into the trained generative language model. In this aspect, additionally or alternatively, a command explanation may be generated by parsing the message into sub-phrases, and categorizing each sub-phrase into categories including at least an action and an action parameter, and synonyms for each sub-phrase. In this aspect, additionally or alternatively, the categories may include predetermined common parameter types including days of the week. In this aspect, additionally or alternatively, the constructions database may be consolidated by merging constructions based on common categories. In this aspect, additionally or alternatively, the constructions database may be updated based on changes in usage detected in inputs from users.

Another aspect provides a computing system for interpreting language. The system comprises processing circuitry and associated memory configured to store a constructions database comprising a plurality of language constructions, receive a plurality of requests including a plurality of messages, respectively, as natural language input from an interaction interface, input the plurality of messages into a trained generative language model to generate a plurality of language constructions corresponding to the plurality of messages, respectively, for each of the generated plurality of language constructions, input a prompt into the trained generative language model to inquire how the language constructions was generated, so as to generate a plurality of construction explanations, incorporate the plurality of construction explanations into the constructions database, consolidate the constructions database based on merging constructions based on common categories, and deploy the constructions database in an agent cache configured to parse a request into semantic components, and translate the semantic components into a structured language format, so as to generate a language construction based on the parsed request.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for interpreting commands, the system comprising:
processing circuitry and associated memory configured to:
store a constructions database comprising a plurality of command constructions; and
execute an orchestrator to:
receive a request including a message as natural language input from an interaction interface;
perform a matching operation that attempts to match the message to one of the plurality of command constructions; and
responsive to successfully matching the message to the one of the plurality of command constructions, generate a command based on the one of the plurality of command constructions, and execute the generated command.

2. The computing system of claim 1, wherein
responsive to failing to match the message to the one of the plurality of command constructions, the orchestrator inputs the message into a trained generative language model to generate a command corresponding to the message, and executes the generated command.

3. The computing system of claim 2, wherein the orchestrator is further configured to:
for the generated command, input a prompt into the trained generative language model to inquire how the command was generated, so as to generate a command explanation; and
incorporate the command explanation into the constructions database.

4. The computing system of claim 3, wherein the generation of the command explanation is refined by inputting external feedback into the trained generative language model.

5. The computing system of claim 2, wherein the trained generative language model generates a command explanation by parsing the message into sub-phrases, and categorizing each sub-phrase into categories including at least an action and an action parameter, and synonyms for each sub-phrase.

6. The computing system of claim 5, wherein the categories include predetermined common parameter types including days of the week.

7. The computing system of claim 5, wherein the constructions database is consolidated by merging constructions based on common categories.

8. The computing system of claim 2, comprising a server computing device and a client computing device, wherein
the orchestrator and the constructions database are stored on the client computing device, and the trained generative language model is stored on the server computing device.

9. The computing system of claim 2, wherein the command is generated by the trained generative language model with a transducer function implementing part-of-speech tagging.

10. The computing system of claim 9, wherein the constructions are formatted as a sequence of semantic components including actions, objects, prepositions, and modifiers.

11. The computing system of claim 1, wherein the constructions database is updated based on changes in usage detected in inputs from users of the computing system.

12. A computing method for interpreting commands, the method comprising:
storing a constructions database comprising a plurality of command constructions;
receiving a request including a message as natural language input from an interaction interface;
performing a matching operation that attempts to match the message to one of the plurality of command constructions; and
responsive to successfully matching the message to the one of the plurality of command constructions, generating a command based on the one of the plurality of command constructions, and executing the generated command.

13. The computing method of claim 12, wherein
responsive to failing to match the message to the one of the plurality of command constructions, the message is inputted into a trained generative language model to generate a command corresponding to the message, and the generated command is executed.

14. The computing method of claim 13, further comprising:
for the generated command, inputting a prompt into the trained generative language model to inquire how the command was generated, so as to generate a command explanation; and
incorporating the command explanation into the constructions database.

15. The computing method of claim 14, wherein the generation of the command explanation is refined by inputting external feedback into the trained generative language model.

16. The computing method of claim 13, wherein a command explanation is generated by parsing the message into sub-phrases, and categorizing each sub-phrase into categories including at least an action and an action parameter, and synonyms for each sub-phrase.

17. The computing method of claim 16, wherein the categories include predetermined common parameter types including days of the week.

18. The computing method of claim 16, wherein the constructions database is consolidated by merging constructions based on common categories.

19. The computing method of claim 12, wherein the constructions database is updated based on changes in usage detected in inputs from users.

20. A computing system for interpreting language, the system comprising:
processing circuitry and associated memory configured to:
store a constructions database comprising a plurality of language constructions;
receive a plurality of requests including a plurality of messages, respectively, as natural language input from an interaction interface;
input the plurality of messages into a trained generative language model to generate a plurality of language constructions corresponding to the plurality of messages, respectively;
for each of the generated plurality of language constructions, input a prompt into the trained generative language model to inquire how the language constructions was generated, so as to generate a plurality of construction explanations;
incorporate the plurality of construction explanations into the constructions database;
consolidate the constructions database based on merging constructions based on common categories; and
deploy the constructions database in an agent cache configured to parse a request into semantic components, and translate the semantic components into a structured language format, so as to generate a language construction based on the parsed request.
